(19) United States
(12) Patent Application Publication
(10) Pub. No.: US 2025/0171041 A1
(43) Pub. Date: May 29, 2025

(54) VEHICULAR DRIVING ASSIST SYSTEM WITH ENHANCED DATA PROCESSING

(71) Applicant: Magna Electronics Inc., Auburn Hills, MI (US)

(72) Inventors: Johannes Staab, Hösbach (DE); Sylvie Wacquant, Mainhausen (DE)

(21) Appl. No.: 18/952,093

(22) Filed: Nov. 19, 2024

Related U.S. Application Data
(60) Provisional application No. 63/602,729, filed on Nov. 27, 2023.

(51) Int. Cl. B60W 50/08; B60W 50/00; G06V 20/59

(52) U.S. Cl. CPC B60W 50/085; B60W 50/0098; G06V 20/597; B60W 2050/0088; B60W 2420/403; B60W 2540/229

(57) ABSTRACT

A method for structuring a vehicular driving assistance system includes determining a function of the vehicular driving assistance system. The method also includes determining one or more state transitions for a state machine of the function of the vehicular driving assistance system, where the state machine comprises a plurality of states, and where the one or more state transitions cause the state machine to transition from a state of the plurality of states to a different state of the plurality of states. The method also includes determining, based on the one or more state transitions, a current state of the plurality of states of the state machine, and generating, based on the current state of the state machine, one or more outputs for the function of the vehicular driving assistance system.

### CROSS REFERENCE TO RELATED APPLICATION

The present application claims the filing benefits of U.S. provisional application Ser. No. 63/602,729, filed Nov. 27, 2023, which is hereby incorporated herein by reference in its entirety.

### FIELD OF THE INVENTION

The present invention relates generally to driving assist systems for a vehicle such as, for example, a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A method for structuring a vehicular driving assistance system includes determining a function of the vehicular driving assistance system. The method also includes determining one or more state transitions for a state machine of the function of the vehicular driving assistance system, where the state machine comprises a plurality of states, and where the one or more state transitions cause the state machine to transition from a state of the plurality of states to a different state of the plurality of states. The method also includes determining, based on the one or more state transitions, a current state of the plurality of states of the state machine. The method includes generating, based on the current state of the state machine, one or more outputs for the function of the vehicular driving assistance system.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a schematic view of decomposition frames for a vehicular driving assistance system of a vehicle;

FIG. 3 is a block diagram of the decomposition frames for a simplified yawn detection sub-feature of a vehicular driving assistance system of a vehicle;

FIG. 4 is a diagram of an example computation of a state machine transition for the yawn detection sub-function of FIG. 3;

FIG. 5 is a diagram of an example computation of a state machine of the yawn detection sub-function of FIG. 3;

FIG. 6 is a processing block diagram example of the yawn detection sub-function of FIG. 3; and

FIG. 7 is a flowchart for a portion of the yawn detection sub-function of FIG. 3.

### DESCRIPTION OF THE PREFERRED EMBODIMENTS

A vehicle sensing system or vehicle vision system and/or driver or driving assist system and/or object detection system and/or alert system operates to capture images exterior or interior of the vehicle and may process the captured image data to display images and to detect, for example, driver or occupant behavior. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like. Optionally, the vision system may receive and/or process sensor data from other available sensors.

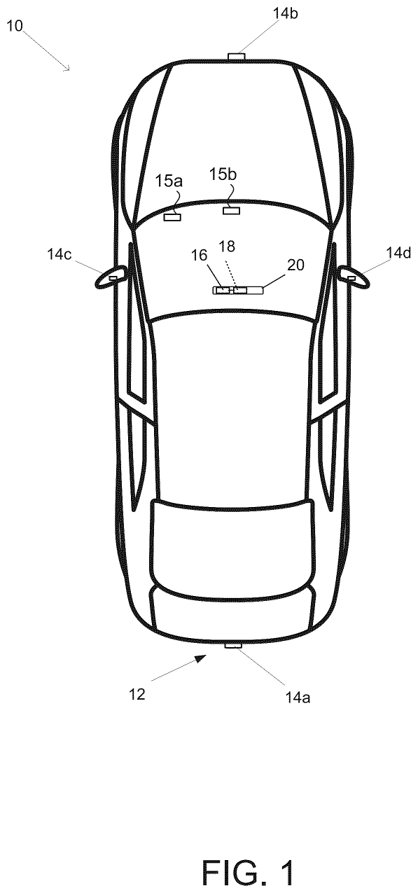

Referring now to the drawings and the illustrative embodiments depicted therein, a vehicle 10 includes an imaging system or driver assistance system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). The vehicle may include one or more additional driver monitoring sensors (e.g., one or more cameras, radar sensors, etc.), such as monitoring sensor 15a, 15b to monitor a driver and/or passenger of the vehicle. Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The driver assistance system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

In the automotive industry, software implementation has become an increasingly important portion of vehicle development. However, the complexity of vehicle software is consequently increasing. Additionally, advanced driver-assistance systems are an important part of current vehicle software supporting vehicle safety. For example, originally ADAS were based mainly on hardware, but in the last few decades the software components of ADAS have gained in importance and complexity.

Current ADAS are made up of multiple different features or functions. These functions eventually share inputs and/or outputs, however the functions are independent of each other. The inputs for these functions may include, for example, equipped vehicle information, automotive imaging, image processing, computer vision, in-car networking, vehicle-to-vehicle (V2V) communication, vehicle-to-infrastructure (V2X) communication, as well as other vehicles communication.

Implementations herein include a simple and universal way to structure and apply systematic, coherent treatment of different cases in application software (e.g., application ADAS software), using, for example, abstraction concepts and separation of concerns. This enables better readability, understanding, re-usability, efficiency, and overall quality improvement for the software.

More specifically, implementations herein concern the architecture elements inside one or more features/functions or sub-features/sub-functions of a vehicular driving assistance system (e.g., an ADAS, such as a lane centering system, an automatic emergency braking system, etc.) as well as a systematic handling of signals of the function in a universal way. For example, one or more implementations leverage modularized, service-oriented architecture and/or separation of concerns. Service-oriented architecture allows the ADAS to perform each task independently of other tasks, which enables easier testing and re-use of legacy programs. Similarly, separation of concerns allows compartmentalization of different components, each handling respective and different responsibilities.

Further, implementations herein organize the software of ADAS functions by decomposing the software into modules, each module dedicated to different computations. A first module (i.e., frame) encompasses the processes of a state machine or a set of state machines. A second module encompasses state transition processing, including data analysis. A third module encompasses processing interface outputs of the ADAS function. This decomposition enhances readability of the software by performing the function's computations in a universal and systematic way. This decomposition further enhances reusability of the software and safety function management, in turn improving the quality of the software.

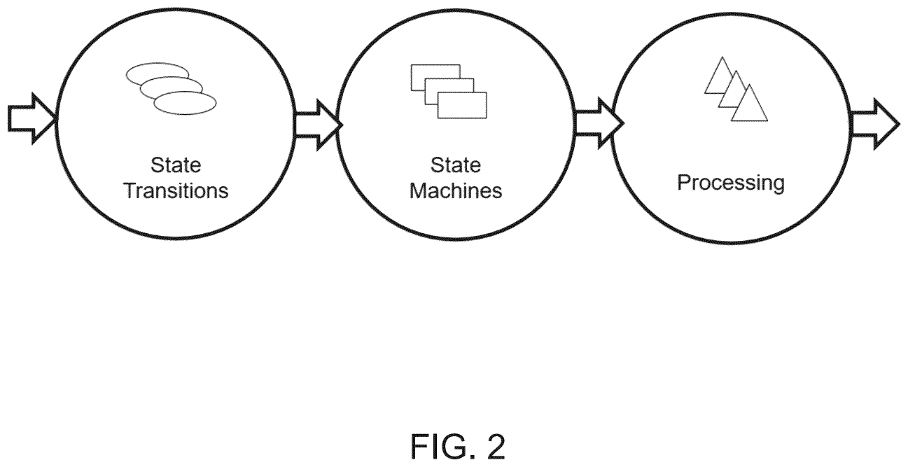

Referring now to FIG. 2, the proposed universal structure enables grouping by topic of the different elements needed in the application software. Typically, outputs of a function of the ADAS depend on a sensor's and/or input's availability as well as on a general state of the ADAS system. Accordingly, each function, as described herein, is associated with at least one state machine to determine a state influencing or at least partially controlling the final outputs of the function/sub-function. Each function may have its own outputs, and thus may require its own state machine.

Due to the increasingly complex input combinations to determine the state for state machines of many ADAS functions, implementations herein may separate the complex state-transition computations from the state machine. This may also concern data analysis for real-time decisions and autonomous driving (if not done with inputs). Additionally, the outputs must be computed. This output processing step may also be complex, requiring its own frame. Output processing refers to determining the values of outputs which will define when and how to warn the driver or intervene on the vehicle (e.g., via a human-machine interface (HMI)).

This structure (FIG. 2) enables a better understanding/readability of the function/sub-function as the structure decomposes elements of the function/sub-function in a universal and systematic way. The structure also enables easier re-usability and efficiency, as the function/sub-function may be adapted to new requirements. The adaptations will likely concern the state transitions, but the adaptations may also include the processing and/or state machine frames. However, the original decompositions in the three frames (i.e., state transitions, state machine, and processing) are still available at higher levels of the ADAS system. This structure enhances the management of safety functions by allowing the processing of sub-functions even if a portion of the inputs are failing. This may also improve the overall quality of the software.

Optionally, implementations herein follow an open/closed principle. That is, software entities (classes, modules, functions, feature, etc.) may be open for extension but closed for modification. This allows extending of behavior without modifying existing code.

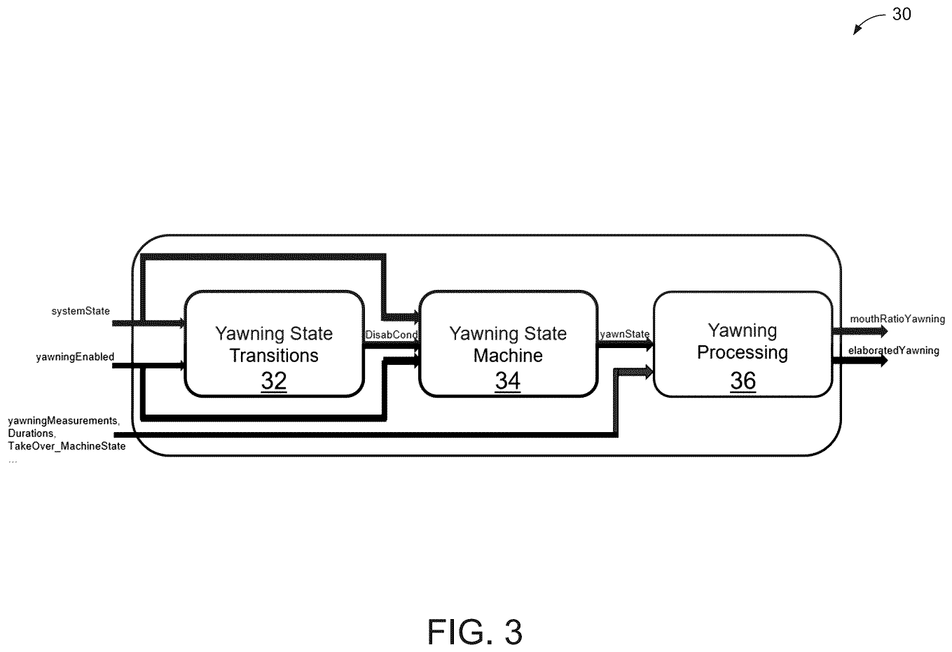

Referring now to FIG. 3, an exemplary block diagram 30 shows a simplified yawning behavior sub-function, which may be a sub-function of a driver monitoring detection function. The block diagram 30 splits the sub-function into the three respective frames: a yawning state transition frame 32, a yawning state machine frame 34, and a yawn processing frame 36. These frames combine to provide the yawning sub-function which generates two outputs for the driver monitoring detection function (i.e., mouthRatioYawning and elaboratedYawning).

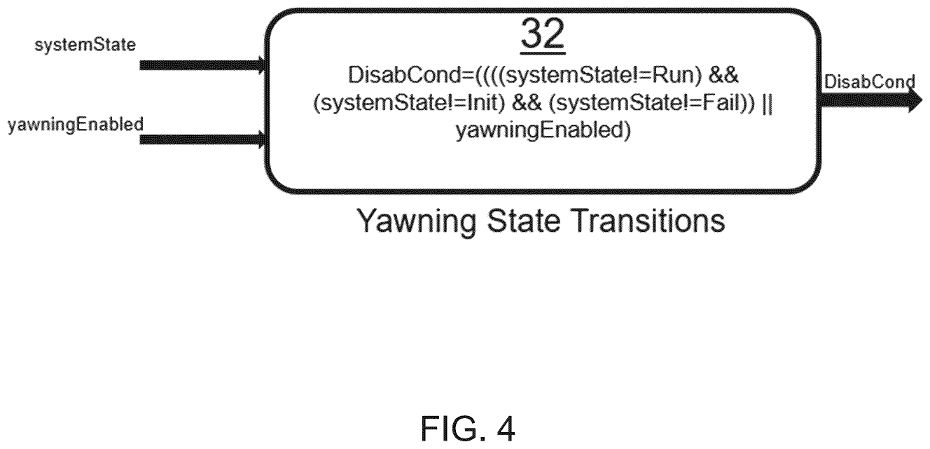

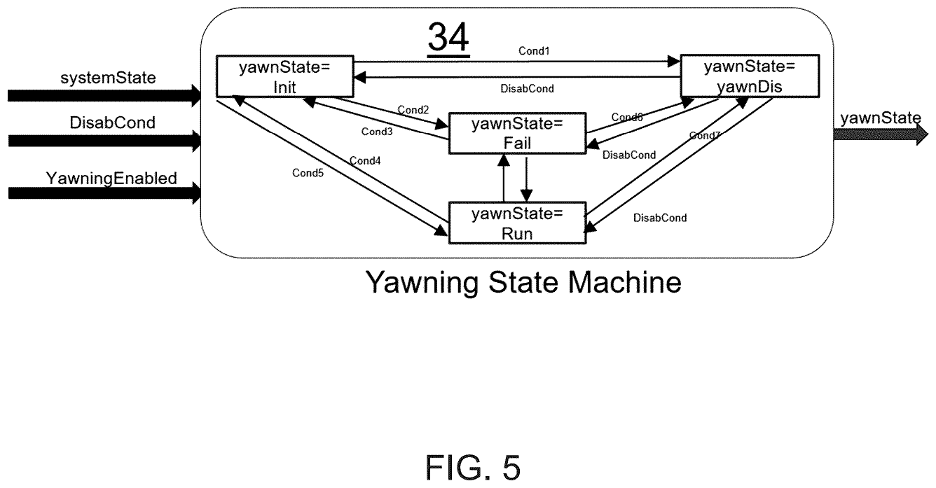

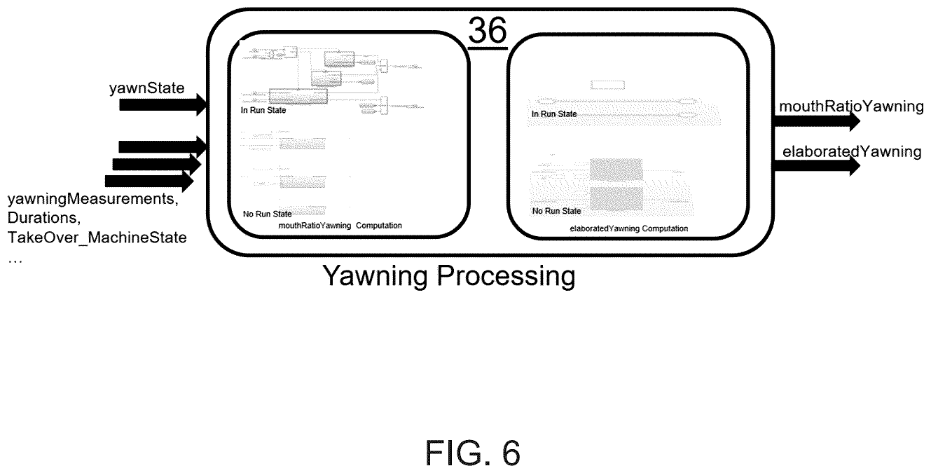

FIG. 4 includes a more detailed view of the yawning state transitions frame 32. The state transitions frame 32 may include transition determinations for state transitions that take longer than a threshold period of time. In this example, the state transitions frame 32 determines whether a “disabled condition” signal (i.e., “DisabCond”) is active based on the current state of the state machine frame 34 (i.e., “systemState”) and a yawning enabled input (i.e., “yawningEnabled”). FIG. 5 includes a more detailed view of the state machine frame 34. The current state of the state machine 34 is based on the outputs from the state transitions frame 32, general information such as the ECU system state, and the current authorizations of the yawning sub-function, etc. FIG. 6 includes a more detailed view of the yawn processing frame 36. The outputs of the yawn processing frame 36 are dependent upon the current state of the state machine 34 and other inputs (e.g., sensor data, such as image data, outputs from other sub-functions, etc.). In this example, two outputs are computed in separate blocks. For each of these two blocks, the output processing depends on the current state (that was previously processed) of the state machine 34 (i.e., “yawnState”).

Optionally, to improve readability and structuration, a constant may force output values of the state machine when the state machine is not in a run state. For example, when a calibration parameter is set to “takeOverStateMachine” (i.e., a takeover condition is true) and a function or sub-function state machine in an initialization state, an error state, and/or an unknown state (this may be adapted based on available states), then the corresponding output value for the initialization state, the error state, and/or the unknown state is delivered (i.e., any values predefined for those states). When the calibration parameter is not set to “takeOverStateMachine” (i.e., the takeover condition is false), the output value may be the value defined by the calibration parameter. Generally, all signals may be assigned a default value (that may be automatically applied) as well as a specification of their values based on the different state machine states (similarly to the “takeOverStateMachine” example).

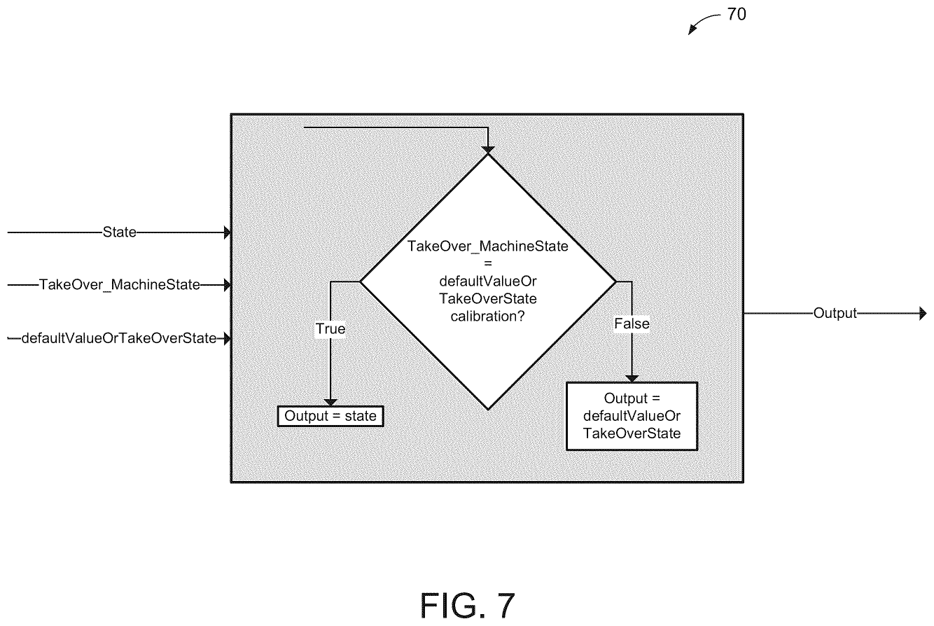

Referring now to FIG. 7, an exemplary flow chart 70 illustrates the process for determining the yawning sub-function outputs when the current state of the state machine 34 is not in the “run” state (i.e., an active or normal state). In a first example, the current state of the state machine is “initialization” (or Init) and the system must determine mouthRatioYawning. In this example, TakeOver_MachineState is equal to defaultValueorTakeOverState (i.e., the calibration parameter). These can be any values as long as they are equal. Accordingly, in this example, mouthRatioYawning is equal to Init. In a second example, the current state of the state machine is Init and the system must determine mouthRatioYawning. In this example, TakeOver_MachineState is equal to a first value and defaultValueorTakeOverState (i.e., the calibration parameter) is equal to a second value that is different from the first value. Accordingly, in this example, mouthRatioYawning is equal to defaultValueorTakeOverState (i.e., the second value).

Thus, implementations herein include structure for software (e.g., software for a vehicular driving assistance system such as a driver monitoring system, occupant monitoring system, or ADAS) to enhance re-use, understanding of the software, and software quality and attendance. For example, some implementations include separating transition state computations from a state machine, which simplifies associated code for better understanding. Additionally or alternatively, processing is also separated from the state machine, providing similar simplification benefits.

Thus, implementations herein include a method for structuring a vehicular driving assistance system including determining a function of the vehicular driving assistance system. The method also includes determining one or more state transitions for a state machine of the function of the vehicular driving assistance system, wherein the state machine comprises a plurality of states, and wherein the one or more state transitions cause the state machine to transition from a state of the plurality of states to a different state of the plurality of states. The method also includes determining, based on the one or more state transitions, a current state of the plurality of states of the state machine. The method includes generating, based on the current state of the state machine, one or more outputs for the function of the vehicular driving assistance system.

In some examples, the vehicular driving assistance system may include a driver monitoring system and/or an occupant monitoring system. In further examples, the function of the vehicular driving assistance system may include a yawn detection function or driver attentiveness or drowsiness or any other feature, sub-feature, function, or sub-function of the vehicular driving assistance system.

In other examples, the plurality of states may include a run state. The plurality of states may further include an initialization state and a failure state.

In further examples, the method may also include, before generating the one or more outputs for the function, and responsive to the determined current state of the state machine not being the run state, determining the one or more outputs for the function based on a calibration parameter. In still further examples, determining the one or more outputs for the function based on the calibration parameter may include overriding each of the one or more outputs for the function with a constant value. In even further examples, determining the one or more outputs for the function based on the calibration parameter may include passing the current state of the state machine as at least one of the one or more outputs.

In some examples, the method may further include, before generating the one or more outputs for the function, and responsive to the determined current state of the state machine being the run state, determining the one or more outputs for the function based on the run state and one or more inputs to the vehicular driving assistance system.

In other examples, determining the one or more state transitions may also include processing image data captured by a camera disposed at a vehicle equipped with the vehicular driving assistance system. The camera may include a driver monitoring camera and the vehicular driving assistance system may include a driver monitoring system.

In further examples, determining the one or more state transitions may include determining that each state transition of the one or more state transitions requires more than a threshold period of time to determine.

Although the implementations herein have been described in the context of software for vehicular driving assistance systems (e.g., a yawning sub-function of a driver monitoring system), the structure for software may be applied to software architectures, systems, and functions in any context.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or the driver/occupants of the vehicle or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827, 153; 11,780,372; 11,639,134; 11,582,425; 11,518,401; 10,958,830; 10,065,574; 10,017,114; 9,405,120 and/or 7,914,187, and/or U.S. Publication Nos. US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. provisional application Ser. No. 63/673,225, filed Jul. 19, 2024 (Attorney Docket DON01 P5202), and/or U.S. provisional application Ser. No. 63/641,574, filed May 2, 2024 (Attorney Docket DON01 P5156), and/or International Publication No. WO 2023/220222, which are all hereby incorporated herein by reference in their entireties.

The driver monitoring or interior-viewing camera may be disposed at the mirror head of an interior rearview mirror assembly and moves together and in tandem with the mirror head when the driver of the vehicle adjusts the mirror head to set his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, a light emitter may be disposed at the lower or chin region of the mirror head below the mirror reflective element of the mirror head (such as to one side or the other of the interior-viewing camera), or a light emitter may be disposed behind the mirror reflective element and emitting light that passes through the mirror reflective element. The ECU (having an image processor for processing image data captured by the camera) may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS, to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A method for structuring a vehicular driving assistance system, the method comprising:
determining a function of the vehicular driving assistance system;
determining one or more state transitions for a state machine of the function of the vehicular driving assistance system, wherein the state machine comprises a plurality of states, and wherein the one or more state transitions cause the state machine to transition from a state of the plurality of states to a different state of the plurality of states;
determining, based on the one or more state transitions, a current state of the plurality of states of the state machine; and
generating, based on the current state of the state machine, one or more outputs for the function of the vehicular driving assistance system.

2. The method of claim 1, wherein the vehicular driving assistance system comprises a driver monitoring system.

3. The method of claim 2, wherein the function comprises a yawn detection function.

4. The method of claim 1, wherein the plurality of states comprises a run state.

5. The method of claim 4, further comprising, before generating the one or more outputs for the function, and responsive to the determined current state of the state machine not being the run state, determining the one or more outputs for the function based on a calibration parameter.

6. The method of claim 5, wherein determining the one or more outputs for the function based on the calibration parameter comprises overriding each of the one or more outputs for the function with a constant value.

7. The method of claim 5, wherein determining the one or more outputs for the function based on the calibration parameter comprises passing the current state of the state machine as at least one of the one or more outputs.

8. The method of claim 4, further comprising, before generating the one or more outputs for the function, and responsive to the determined current state of the state machine being the run state, determining the one or more outputs for the function based on the run state and one or more inputs to the vehicular driving assistance system.

9. The method of claim 4, wherein the plurality of states comprises an initialization state and a failure state.

10. The method of claim 1, wherein determining the one or more state transitions comprises processing image data captured by a camera disposed at a vehicle equipped with the vehicular driving assistance system.

11. The method of claim 10, wherein the camera comprises a driver monitoring camera, and wherein the vehicular driving assistance system comprises a driver monitoring system.

12. The method of claim 1, wherein determining the one or more state transitions comprises determining that each state transition of the one or more state transitions requires more than a threshold period of time to determine.

13. A method for structuring a vehicular driving assistance system, the method comprising:
determining a function of the vehicular driving assistance system;
determining one or more state transitions for a state machine of the function of the vehicular driving assistance system, wherein the state machine comprises a plurality of states, and wherein the plurality of states comprises a run state, an initialization state, and a failure state, and wherein the one or more state transitions cause the state machine to transition from a state of the plurality of states to a different state of the plurality of states;
determining, based on the one or more state transitions, a current state of the plurality of states of the state machine; and
generating, responsive to the determined current state not being the run state, one or more outputs for the function of the vehicular driving assistance system based on a calibration parameter.

14. The method of claim 13, wherein the vehicular driving assistance system comprises a driver monitoring system.

15. The method of claim 13, wherein determining the one or more outputs for the function based on the calibration parameter comprises overriding each of the one or more outputs for the function with a constant value.

16. The method of claim 13, wherein determining the one or more outputs for the function based on the calibration parameter comprises passing the current state of the state machine as at least one of the one or more outputs.

17. The method of claim 13, wherein determining the one or more state transitions comprises determining that each state transition of the one or more state transitions requires more than a threshold period of time to determine.

18. A method for structuring a vehicular driving assistance system, the method comprising:
determining a function of the vehicular driving assistance system;
determining one or more state transitions for a state machine of the function of the vehicular driving assistance system, wherein the state machine comprises a plurality of states, and wherein the plurality of states comprises a run state, an initialization state, and a failure state, and wherein the one or more state transitions cause the state machine to transition from a state of the plurality of states to a different state of the plurality of states;
determining, based on the one or more state transitions, a current state of the plurality of states of the state machine; and
generating, responsive to the determined current state being the run state, one or more outputs for the function of the vehicular driving assistance system based on one or more inputs to the vehicular driving assistance system.

19. The method of claim 18, wherein the vehicular driving assistance system comprises driver monitoring system.

20. The method of claim 19, wherein determining the one or more state transitions comprises determining that each state transition of the one or more state transitions requires more than a threshold period of time to determine.
